(19) United States
(12) Patent Application Publication
(10) Pub. No.: US 2023/0054180 A1
(43) Pub. Date: Feb. 23, 2023

(54) SYSTEM AND METHOD FOR PERFORMING SPRAYING OPERATIONS WITH AN AGRICULTURAL APPLICATOR

(71) Applicant: CNH Industrial America LLC, New Holland, PA (US)

(72) Inventor: Roy A. Bittner, Cato, WI (US)

(73) Assignee: CNH Industrial America LLC

(21) Appl. No.: 17/404,602

(22) Filed: Aug. 17, 2021

(51) Int. Cl. A01M 7/00; B05B 12/12; B05B 1/20

(52) U.S. Cl. CPC A01M 7/0089; B05B 12/124; B05B 1/20; A01M 7/006; G05B 15/02

(57) ABSTRACT

A system for an agricultural vehicle includes a boom assembly and a nozzle assembly positioned along the boom assembly. A position sensor is associated with the boom assembly. A field sensor is also associated with the nozzle assembly. A computing system is operably coupled with the nozzle assembly, the position sensor, and the field sensor. The computing system is configured to detect a target within a field based on data from the field sensor, determine a boom deflection model based on data from the position sensor, and activate the nozzle assembly to apply an agricultural product to the target based on the boom deflection model.

### FIELD

The present disclosure generally relates to agricultural applicators for performing spraying operations within a field and, more particularly, to systems and methods for performing spraying operations with an agricultural sprayer, such as spraying operations that allow for selective application of an agricultural product onto plants.

### BACKGROUND

Agricultural sprayers apply an agricultural product (e.g., a pesticide, a nutrient, and/or the like) onto crops and/or a ground surface as the sprayer is traveling across a field. To facilitate such travel, sprayers can be configured as self-propelled vehicles or implements towed behind an agricultural tractor or another suitable work vehicle. In some instances, the sprayer includes an outwardly extending boom assembly having a plurality of boom sections supporting a plurality of spaced-apart nozzle assemblies. Each nozzle assembly has a valve configured to control the spraying of the agricultural product through a nozzle onto underlying targets, which may include crops and/or weeds. The boom assembly is disposed in a “cantilevered” arrangement during the spraying operation, wherein the boom sections are extended to cover wide swaths of the field. For transport, the boom assembly is folded to reduce the width of the sprayer.

Some sprayers may control the flow of agricultural product through individual nozzles to apply the agricultural product to defined targets. However, under certain operating conditions, some or all of the nozzle assemblies may move from a default position as the boom is deflected causing misapplications of the agricultural product. Accordingly, an improved system and method for performing spraying operations with an agricultural sprayer would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system for an agricultural vehicle that includes a boom assembly and a nozzle assembly positioned along the boom assembly. A position sensor is associated with the boom assembly. A field sensor is associated with the nozzle assembly. A computing system is operably coupled with the nozzle assembly, the position sensor, and the field sensor. The computing system is configured to detect a target within a field based on data from the field sensor; determine a boom deflection model based on data from the position sensor; and activate the nozzle assembly to apply an agricultural product to the target based on the boom deflection model.

In some aspects, the present subject matter is directed to a method for selectively applying an agricultural product. The method includes receiving, with a computing system, data indicative of one or more objects within a field. The method also includes identifying, with the computing system, a target from the one or more objects. The method further includes receiving, with the computing system, boom data related to curvature of a boom assembly relative to a frame. Lastly, the method includes determining, with the computing system, a boom deflection model based on the boom data.

In some aspects, the present subject matter is directed to a system for an agricultural vehicle includes a boom assembly and a nozzle assembly positioned along the boom assembly. A position sensor is associated with the boom assembly. A computing system is operably coupled with the nozzle assembly and the position sensor, the computing system configured to receive data from the position sensor; determine a boom deflection model based on the data from the position sensor; and determine a boundary of an application region based on the boom deflection model.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural sprayer in accordance with aspects of the present subject matter;

FIG. 2 illustrates a side view of the agricultural sprayer in accordance with aspects of the present subject matter;

FIG. 3 illustrates a simplified, schematic view of a boom arm of a boom assembly in accordance with aspects of the present subject matter, particularly illustrating the boom arm being deflected in a fore and an aft direction;

FIG. 4 is a front perspective view of the boom assembly including a plurality of nozzle assemblies positioned there along in accordance with aspects of the present subject matter;

FIG. 5 illustrates a block diagram of components of a system for selectively applying an agricultural product in accordance with aspects of the present subject matter;

FIG. 6 is a simplified schematic representation of a boom assembly including a first nozzle assembly and a second nozzle assembly each positioned a first distance from various objects in accordance with aspects of the present subject matter;

FIG. 7 is a simplified schematic representation of a boom assembly including the first nozzle assembly and the second nozzle assembly of FIG. 6 with the boom assembly in a default position in accordance with aspects of the present subject matter;

FIG. 8 is a simplified schematic representation of a boom assembly including the first nozzle assembly and the second nozzle assembly of FIG. 6 with the boom assembly in a deflected position in accordance with aspects of the present subject matter; and

FIG. 9 illustrates a flow diagram of a method of selectively applying an agricultural product in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a system for an agricultural vehicle. The system includes a boom assembly. A nozzle assembly is positioned along the boom assembly.

A position sensor is associated with the boom assembly. The position sensor can be configured to output data indicative of a measured boom position relative to a default axis. A field sensor is also associated with the nozzle assembly. The field sensor may be configured to capture data indicative of field conditions within the field. In several embodiments, the field sensor may be able to capture data indicative of objects and/or field conditions within an underlying field.

A computing system is operably coupled with the nozzle assembly, the position sensor, and the field sensor. The computing system may be configured to detect a target within a field based on data from the field sensor. The computing system may also be configured to determine a boom deflection model based on data from the position sensor. The boom deflection model may predict or determine a magnitude of fore-aft deflection (and/or any other direction) of the boom assembly and/or a speed of movement of the first nozzle and the second nozzle relative to the underlying field and/or relative to the vehicle. The computing system may further be configured to activate the nozzle assembly to apply an agricultural product to the target based on the boom deflection model. By utilizing data from the position sensor to determine a boom deflection model, processing speeds of the computing system may be increased, which may allow for the sprayer to move along an underlying field at quicker speeds.

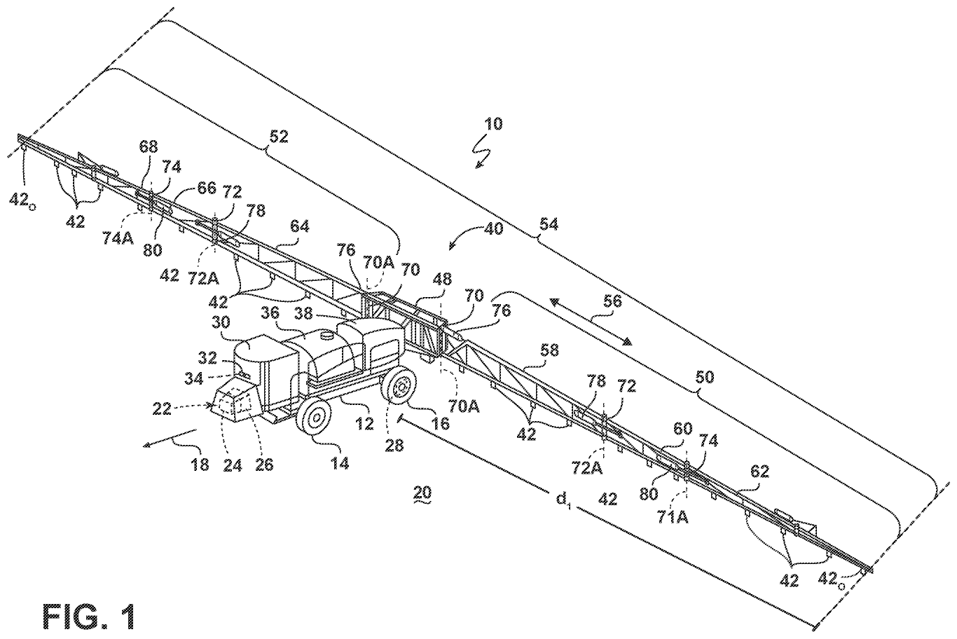

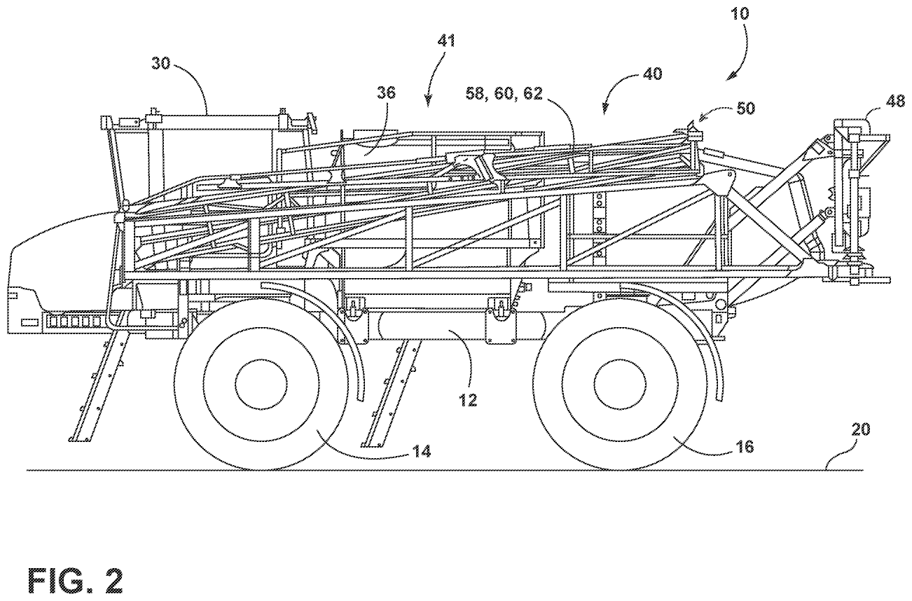

Referring now to FIGS. 1 and 2, an agricultural applicator is generally illustrated as a self-propelled agricultural sprayer 10. However, in alternative embodiments, the agricultural applicator may be configured as any other suitable type of the agricultural applicator configured to perform an agricultural spraying or other product application operations, such as a tractor or other work vehicle configured to haul or tow an applicator implement.

In some embodiments, such as the one illustrated in FIG. 1, the agricultural sprayer 10 may include a chassis 12 configured to support or couple to a plurality components. For example, front and rear wheels 14, 16 may be coupled to the chassis 12. The wheels 14, 16 may be configured to support the agricultural sprayer 10 relative to a ground surface and move the agricultural sprayer 10 in a direction of forward travel 18 across a field 20. In this regard, the agricultural sprayer 10 may include a powertrain control system 22 that includes a power plant 24, such as an engine, a motor, or a hybrid engine-motor combination, a transmission system 26 configured to transmit power from the engine to the wheels 14, 16, and/or a brake system 28.

The chassis 12 may also support a cab 30, or any other form of operator's station, that houses various control or input devices (e.g., levers, pedals, control panels, buttons, and/or the like) for permitting an operator to control the operation of the sprayer 10. For instance, as shown in FIG. 1, the agricultural sprayer 10 may include a user interface 32, such as a human-machine interface (HMI), for providing messages and/or alerts to the operator and/or for allowing the operator to interface with the vehicle's controller through one or more user-input devices 34 (e.g., levers, pedals, control panels, buttons, and/or the like) within the cab 30 and/or in any other practicable location.

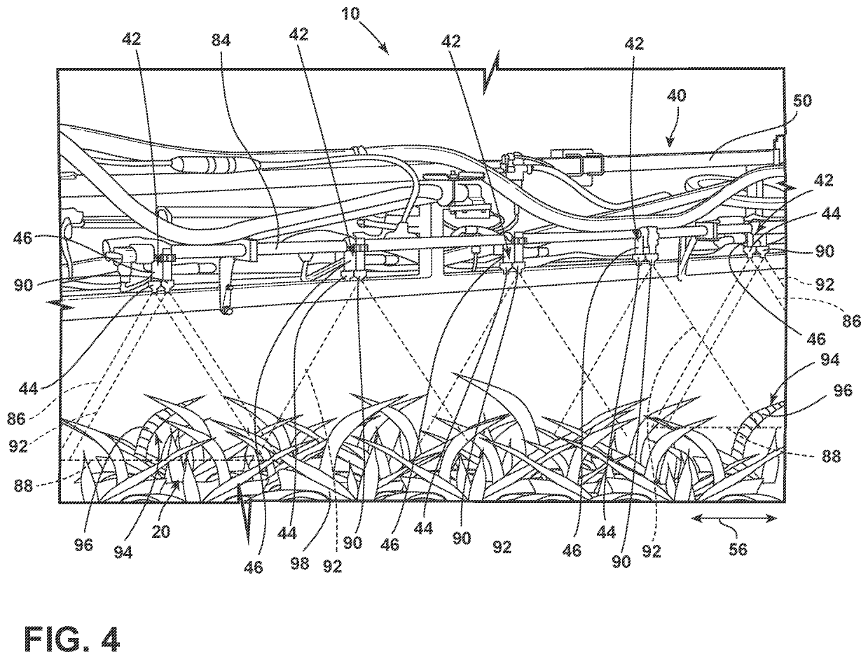

The chassis 12 may also support a product system 41. The product system 41 can include one or more tanks, such as a product tank 36 and/or a rinse tank 38. The product tank 36 is generally configured to store or hold an agricultural product, such as a pesticides (e.g., herbicides, insecticides, rodenticides, etc.) and/or a nutrients. The agricultural product is conveyed from the product tank 36 and/or the rinse tank 38 through a product circuit including various plumbing components, such as interconnected pieces of tubing, for release onto the underlying field 20 (e.g., plants and/or soil) through one or more nozzle assemblies 42 mounted on the boom assembly 40 (or the sprayer 10). Each nozzle assembly 42 may include, for example, a spray nozzle 44 (FIG. 4) and an associated valve 46 (FIG. 4) for regulating the flow rate of the agricultural product through the nozzle 44 (and, thus, the application rate of the nozzle assembly 42), thereby allowing the desired spray characteristics of the output or spray fan of the agricultural product expelled from the nozzle 44 to be achieved. In some instances, each valve 46 may be selectively activated to direct an agricultural product towards a defined target 94 (FIG. 4). For instance, each valve 46 may be selectively activated to exhaust a suitable herbicide towards a detected/identified weed and/or a nutrient towards a detected/identified crop.

The chassis 12 may further support a boom assembly 40 that can include a frame 48 that supports first and second boom arms 50, 52, which may be orientated in a cantilevered nature. The first and second boom arms 50, 52 are generally movable between an operative or unfolded position (FIG. 1) and an inoperative or folded position (FIG. 2). When distributing the agricultural product, the first boom arm and/or the second boom arm 50, 52 extends laterally outward from the agricultural sprayer 10 to the operative position in order to cover wide swaths of the underlying ground surface, as illustrated in FIG. 1. When extended, each boom arm 50, 52 defines a first lateral distance d₁ defined between the frame 48 and an outer end portion of the boom arms 50, 52. Further, the boom arms 50, 52, when both unfolded, define a field swath 54 between respective outer nozzle assemblies 42ₒ of the first and second boom arms 50, 52 that is generally commensurate with an area of the field 20 to which the agricultural sprayer 10 covers during a pass across a field 20 to perform the agricultural operation. However, it will be appreciated that in some embodiments, a single boom arm 50, 52 may be utilized during the application operation. In such instances, the field swath 54 may be an area defined between a pair of nozzle assemblies 42 that are furthest from one another in a lateral direction 56.

To facilitate transport, each boom arm 50, 52 of the boom assembly 40 may be independently folded forwardly or rearwardly into the inoperative position, thereby reducing the overall width of the sprayer 10, or in some examples, the overall width of a towable implement when the applicator is configured to be towed behind the agricultural sprayer 10.

Each boom arm 50, 52 of the boom assembly 40 may generally include one or more boom sections. For instance, in the illustrated embodiment, the first boom arm 50 includes three boom sections, namely a first inner boom section 58, a first middle boom section 60, and a first outer boom section 62, and the second boom arm 52 includes three boom sections, namely a second inner boom section 64, a second middle boom section 66, and a second outer boom section 68. In such an embodiment, the first and second inner boom sections 58, 64 may be pivotably coupled to the frame 48. Similarly, the first and second middle boom sections 60, 66 may be pivotably coupled to the respective first and second inner boom sections 58, 64, while the first and second outer boom sections 62, 68 may be pivotably coupled to the respective first and second middle boom sections 60, 66. For example, each of the inner boom sections 58, 64 may be pivotably coupled to the frame 48 at pivot joints 70. Similarly, the middle boom sections 60, 66 may be pivotally coupled to the respective inner boom sections 58, 64 at pivot joints 72, while the outer boom sections 62, 68 may be pivotably coupled to the respective middle boom sections 60, 66 at pivot joints 74.

As is generally understood, pivot joints 70, 72, 74 may be configured to allow relative pivotal motion between the adjacent boom sections of each boom arm 50, 52. For example, the pivot joints 70, 72, 74 may allow for articulation of the various boom sections between a fully extended or working position (e.g., as shown in FIG. 1), in which the boom sections are unfolded along the lateral direction 56 of the boom assembly 40 to allow for the performance of an agricultural spraying operation, and a transport position (FIG. 2), in which the boom sections are folded inwardly to reduce the overall width of the boom assembly 40 along the lateral direction 56. It should be appreciated that, although each boom arm 50, 52 is shown in FIG. 1 as including three individual boom sections coupled along opposed sides of the central boom section, each boom arm 50, 52 may generally have any suitable number of boom sections.

Additionally, as shown in FIG. 1, the boom assembly 40 may include inner fold actuators 76 coupled between the inner boom sections 58, 64 and the frame 48 to enable pivoting or folding between the fully-extended working position and the transport position. For example, by retracting/extending the inner fold actuators 76, the inner boom sections 58, 64 may be pivoted or folded relative to the frame 48 about a pivot axis 70A defined by the pivot joints 70. Moreover, the boom assembly 40 may also include middle fold actuators 78 coupled between each inner boom section 58, 64 and its adjacent middle boom section 60, 66 and outer fold actuators 80 coupled between each middle boom section 60, 66 and its adjacent outer boom section 62, 68. As such, by retracting/extending the middle and outer fold actuators 78, 80, each middle and outer boom section 60, 66, 62, 68 may be pivoted or folded relative to its respective inwardly adjacent boom section 58, 64, 60, 66 about a respective pivot axis 72A, 74A. When moving to the transport position, the boom assembly 40 and fold actuators 76, 78, 80 are typically oriented such that the pivot axes 70A, 72A, 74A are generally parallel to the vertical direction and, thus, the various boom sections 58, 64, 60, 66, 62, 68 of the boom assembly 40 are configured to be folded horizontally (e.g., parallel to the lateral direction 56) about the pivot axes 70A, 72A, 74A to keep the folding height of the boom assembly 40 as low as possible for transport. However, the pivot axes 70A, 72A, 74A may be oriented along any other suitable direction.

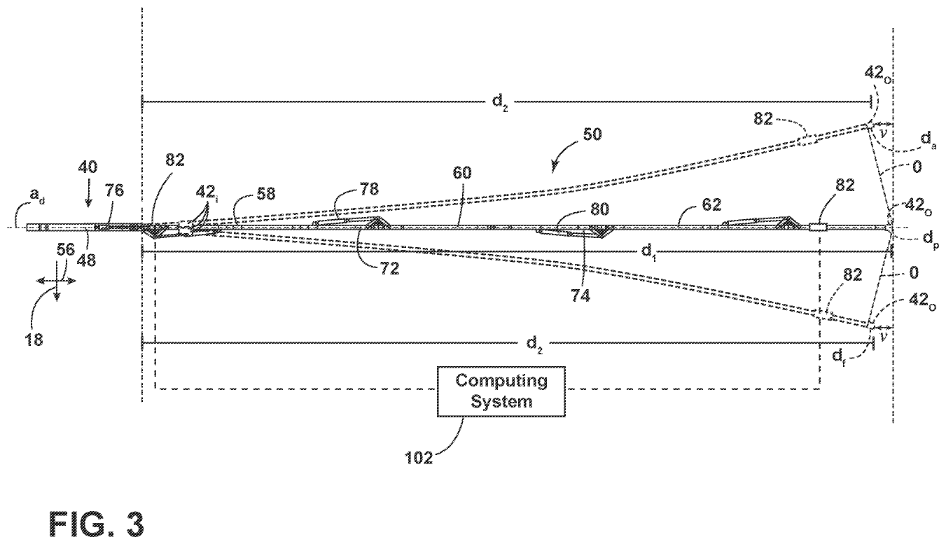

Referring to FIG. 3, prior to performing an agricultural operation with the boom assembly 40, either boom arm 50, 52 may be configured to extend laterally outward thereby placing an outer nozzle assembly 42ₒ a first lateral distance d₁ away from the frame 48 along a default axis a_{d} and/or an outer end portion of each boom arm 50, 52. In various embodiments, the default axis a_{d} may generally be perpendicular relative to the direction of forward travel 18 such that the default axis a_{d} is generally aligned with the lateral direction 56. The first lateral distance d₁ can be defined as a distance between the frame 48 and an outer nozzle assembly 42ₒ Moreover, when the first and second boom arms 50, 52 are extended from opposing sides of the frame 48, the boom arms 50, 52 can define a field swath 54 (FIG. 1) between the outer nozzle assemblies 42ₒ of the first and second boom arms 50, 52, or between the outer end portions of the first and second boom arms 50, 52 depending on the agricultural operation and/or a specific spray operation. Further, in some operations, a single boom arm 50, 52 may be used. In such instances, the field swath 54 may be defined between an outer and an inner operating nozzle assembly 42ᵢ, 42ₒ. It will be appreciated that although the inner operating nozzle assembly 42ᵢ is illustrated as being positioned on the boom arm 50, 52, the inner operating nozzle assembly 42, may alternatively be positioned on the frame 48 without departing from the teachings provided herein. It will be appreciated that although boom arm 50 is generally illustrated in FIG. 3, any boom arm 50, 52 of the boom assembly 40 may operate in a similar manner without departing from the scope of the present disclosure.

During operation, various forces may be placed on the boom assembly 40 causing the boom arms 50, 52 and, consequently, the nozzle assemblies 42 positioned along the boom arms 50, 52, to be deflected or repositioned relative to the frame 48 and/or sprayer 10. For instance, a portion of the boom assembly 40 may be deflected from an assumed or a default position dₚ due to dynamic forces encountered when the sprayer 10 is turned, accelerated, or decelerated. In addition, terrain variations and weather variances may also cause deflection of the boom assembly 40. Further, a portion of the boom assembly 40 may come in contact with an object, thereby leading to deflection of the boom assembly 40.

Once the boom arm 50 is deflected in a fore direction d_{f} (i.e., a direction of forward travel 18) and/or in an aft direction dₐ (i.e., an opposing direction of the direction of forward travel 18) of its default position dₚ, as respectively illustrated in dotted lines in FIG. 3, the outer nozzle assembly 42ₒ may be positioned a second lateral distance d₂ from the frame 48, which may be less than the first lateral distance d₁ due to a curvature of the boom assembly 40. Accordingly, a lateral variance v is formed between the first and second lateral distances d₁, d₂. This lateral variance v may lead to a misapplication of an agricultural product to the underlying field 20. In addition to creating a variance v, the deflection of the boom arm 50 also creates an offset between the outer nozzle assembly 42ₒ in the default position dₚ and the deflected positions d_{f} dₐ, which may also lead to inaccuracies during application of the agricultural product to the underlying field 20.

In embodiments that utilize a boom arm 50 that is supported by the frame 48 in a cantilevered orientation (or any other non-uniform orientation), such as the one illustrated in FIG. 3, the outer nozzle assembly 42ₒ will have a greater deflection magnitude from its default position dₚ than the inner nozzle assembly 42ᵢ. Once the deflective force is overcome and/or no longer present, the boom arm 50 will move back towards its default position dₚ. In some embodiments, the movement of the boom arm 50 may generally occur as harmonic oscillations across the default axis a_{d} such that the boom arm 50 may move from a position at least partially aft of the default axis a_{d} to the default position dₚ and then to a position at least partially fore of the default position dₚ and so on. During the oscillations, an acceleration or speed of an inner nozzle assembly 42ᵢ will be less than the outer nozzle assembly 42ₒ due to the varied deflection magnitudes along the boom arm 50.

With further reference to FIG. 3, a position sensor 82 can be configured to output data indicative of a measured boom position at defined locations along the boom arms 50, 52. The data indicative of the measured boom position may include, but is not limited to, a measured boom height, a measured pitch angle, a measured yaw angle, a measured pressure, a measured velocity, a measured acceleration/deceleration, and/or a measured roll angle of the sprayer 10 and/or the boom assembly 40. The boom position data detected by the position sensor 82 may allow the sprayer 10 to calculate a curvature of the respective boom arms 50, 52. With a calculated boom curvature, the deflection of each nozzle 42 along the boom arms 50, 52 may be determined. In addition, a direction and speed of movement of each nozzle assembly 42 may also be calculated.

In some examples, a first position sensor 82 may be positioned on one of the boom arms 50, 52 at a position proximate to the frame 48 and a second position sensor 82 may be positioned on proximate the outer portion of the boom assembly 40. Based on the relationship of the first position sensor 82 to the second position sensor 82, an estimated deflection or curvature of the boom assembly 40 may be calculated. In other examples, a single position sensor 82, which may be mounted on the boom arms 50, 52, may be used to calculate an estimated curvature of the boom assembly 40. In still yet other examples, the position sensor 82 may be positioned on the frame 48 and/or the sprayer 10 and monitor the boom assembly 40 remotely such that the boom assembly 40 is free of position sensors 82 and the estimated curvature of the boom assembly 40 is calculated by the remote position sensor 82.

In some embodiments, based on the detected and/or calculated position of various portions of the boom arm 50 at known time periods, a speed or acceleration of each nozzle assembly 42 along the boom arm 50 may be calculated to define a boom deflection model. The boom deflection model may map a deflection of each nozzle assembly 42 from a default axis a_{d}, a nozzle speed or acceleration, and/or a direction of movement of each nozzle assembly 42 relative to the frame 48 (or other component of the sprayer 10). Thus, the boom deflection model may be used to determine an upcoming activation time for one or more nozzle assemblies 42 to exhaust the agricultural product on a defined target 94. In various embodiments, the boom deflection model may be determined through various geometric equations, lookup tables (LUTs), and/or any other method to determine a position, a speed, and/or an acceleration of each nozzle 44. Furthermore, the boom deflection model may also provide a prediction of movement of each nozzle 44 at some future time based on the current boom assembly conditions, nozzle conditions, sprayer conditions, environmental conditions, and/or any other conditions. Based on the boom deflection model, the timing of the deposition of the agricultural product may be altered to selectively spray the target 94 and/or a nozzle 44 to be used for exhausting agricultural product towards the target 94 may be chosen. In some instances, by using a boom deflection model, processing requirements may be lessened when compared to calculating each speed at all times, thereby making the system more responsive and/or allowing for faster sprayer speeds.

In some embodiments, the position sensor 82 may be configured as a strain gauge that detects strain indicative of the deflection of at least one of the boom arm 50 at a joint 70, 72, 74 of the boom assembly 40. In various embodiments, the position sensor 82 may be configured as one or more capacitive displacement sensors, Hall effect sensors, string potentiometers, or the like. Based on the detected strain at a defined position along the boom arm 50, a curvature of the boom arm 50 may be calculated. Based on the curvature of the boom arm 50, the computing system 102 determine a boom deflection model that may map a deflection of each nozzle assembly 42 from a default axis a_{d}, a nozzle speed or acceleration, and/or a direction of movement of each nozzle assembly 42 relative to the frame 48 (or other component of the sprayer 10).

Additionally, and/or alternatively, in some examples, the position sensor 82 may be configured as an inertial measurement unit (IMU) that measures a specific force, angular rate, and/or an orientation of the boom arm 50 using a combination of accelerometers, gyroscopes, magnetometers, and/or any other practicable device. The accelerometer may correspond to one or more multi-axis accelerometers (e.g., one or more two-axis or three-axis accelerometers) such that the accelerometer may be configured to monitor the curvature of the boom assembly 40 in multiple directions, such as by sensing the boom arm acceleration along three different axes. It will be appreciated, however, that the accelerometer may generally correspond to any suitable type of accelerometer without departing from the teachings provided herein. Based on the curvature of the boom arm 50, the computing system 102 may determine a boom deflection model that may map a deflection of each nozzle assembly 42 from a default axis a_{d}, a nozzle speed or acceleration, and/or a direction of movement of each nozzle assembly 42 relative to the frame 48 (or other component of the sprayer 10).

With further reference to FIG. 3, in accordance with aspects of the present subject matter, the one or more position sensors 82 may additionally or alternatively correspond to an image sensor. In various embodiments, the image sensors may correspond to a stereographic camera having two or more lenses with a separate image sensor for each lens to allow the camera to capture stereographic or three-dimensional images. However, in alternative embodiments, the image sensors may correspond to any other suitable sensing devices configured to capture image or image-like data, such as a monocular camera, a LIDAR sensor, and/or a RADAR sensor.

In embodiments incorporating an image sensor, each image sensor may be coupled to or mounted on the boom assembly 40 and configured to detect image data relating to a location of an object separated from the boom arm 50 at two instances with a defined time period between the two instances. As such, the computing system 102 can calculate an acceleration, orientation, and movement direction of the boom arm 50 based on the image data. Based on the calculated movement and/or position of the boom arm 50, the computing system 102 may further determine a curvature of the boom arm 50 based on the two instances. Based on the curvature of the boom arm 50, the computing system 102 may determine a boom deflection model that may map a deflection of each nozzle assembly 42 from a default axis a_{d}, a nozzle speed or acceleration, and/or a direction of movement of each nozzle assembly 42 relative to the frame 48 (or other component of the sprayer 10).

In some embodiments, the position sensors 82 may additionally or alternatively correspond to one or more fluid conduit pressure sensors. In general, the pressure sensors may be configured to capture data indicative of the pressure of the agricultural product being supplied to the nozzle assemblies 42. As such, the pressure sensors may be provided in fluid communication with one of the fluid conduits 84 (FIG. 4) that fluidly couple the product tank 36 (FIG. 1) and/or the rinse tank 38 (FIG. 1) to the nozzle assemblies 42. For example, the pressure sensor may correspond to a diaphragm pressure sensor, a piston pressure sensor, a strain gauge-based pressure sensor, an electromagnetic pressure sensor, and/or the like. In operation, as the boom arm 50 deflects, pressure variances may be caused along the fluid conduit 84. Accordingly, by measuring the pressure variances through the position sensor 82, the computing system 102 may be capable of determining an estimated boom arm curvature. Based on the curvature of the boom arm 50, the computing system 102 may determine a boom deflection model that may map a deflection of each nozzle assembly 42 from a default axis a_{d}, a nozzle speed or acceleration, and/or a direction of movement of each nozzle assembly 42 relative to the frame 48 (or other component of the sprayer 10).

In various embodiments, the position sensors 82 may additionally or alternatively correspond to one or more airspeed sensors. In general, the airspeed sensors may be configured to capture data indicative of the airspeed of the air flowing past the boom assembly 40. The airspeed data may, in turn, be indicative of the speed at which the air moves relative to the boom assembly 40. In this respect, airspeed data may consider both the airflow caused by the movement of the boom arm 50 relative to the ground and the airflow caused by any wind that is present. For example, the airspeed sensors may correspond to a pitot tube, an anemometer, and/or the like. By measuring the movement of the boom arm 50 relative to the ground through the position sensor 82, the computing system 102 may be capable of determining an estimated boom arm curvature. Based on the curvature of the boom arm 50, the computing system 102 may determine a boom deflection model that may map a deflection of each nozzle assembly 42 from a default axis a_{d}, a nozzle speed or acceleration, and/or a direction of movement of each nozzle assembly 42 relative to the frame 48 (or other component of the sprayer 10).

Referring now to FIG. 4, a front perspective view of the boom assembly 40 including a plurality of nozzle assemblies 42 positioned there along is illustrated in accordance with aspects of the present subject matter. In some embodiments, each nozzle assembly 42 may be configured to dispense the agricultural product stored within the tank 36 (FIG. 1) and/or the rinse tank 38 (FIG. 1) onto a target 94. In several embodiments, the nozzle assemblies 42 may be mounted on and/or coupled to the first and/or second boom arms 50, 52 of the boom assembly 40, with the nozzle assemblies 42 being spaced apart from each other along the lateral direction 56. Furthermore, fluid conduits 84 may fluidly couple the nozzle assemblies 42 to the tank 36 (FIG. 1) and/or the rinse tank 38 (FIG. 1). In this respect, as the sprayer 10 travels across the field 20 in the direction of forward travel 18 (FIG. 1) to perform a spraying operation, the agricultural product moves from the tank 36 and/or the rinse tank 38 through the fluid conduits 84 to each of the nozzle assemblies 42. The nozzles 44 may, in turn, dispense or otherwise spray a fan 86 of the agricultural product onto the target 94 when the target 94 is in an application region 88 that corresponds to an area for which the agricultural product exhausted from the nozzle 44 may contact. In various instances, the application region 88 may be varied based on a variety of factors, which can include, but are not limited to, nozzle conditions (e.g., type of nozzle (flat fan nozzle, dual pattern nozzle, hollow cone nozzles, etc.), size of nozzle, position of nozzle, wear pattern of nozzle, etc.), sprayer conditions (e.g., speed of the sprayer 10, direction of travel of the sprayer 10, acceleration of the sprayer 10, etc.), boom conditions (e.g., speed of the nozzle assembly 42, deflection magnitude of the assembly 42 from a default position dₚ, acceleration of the nozzle assembly 42, direction of movement of the nozzle assembly 42 relative to the frame 48 and/or the underlying field 20, etc.), environmental conditions (e.g., wind speed, wind direction, percent humidity, ambient temperature, etc.), and/or any other conditions.

In some embodiments, the nozzle assembly 42 may include one or more nozzles 44 having varied spray characteristics. As such, the nozzle assembly 42 may vary the application region 88 based on the selected nozzle 44.

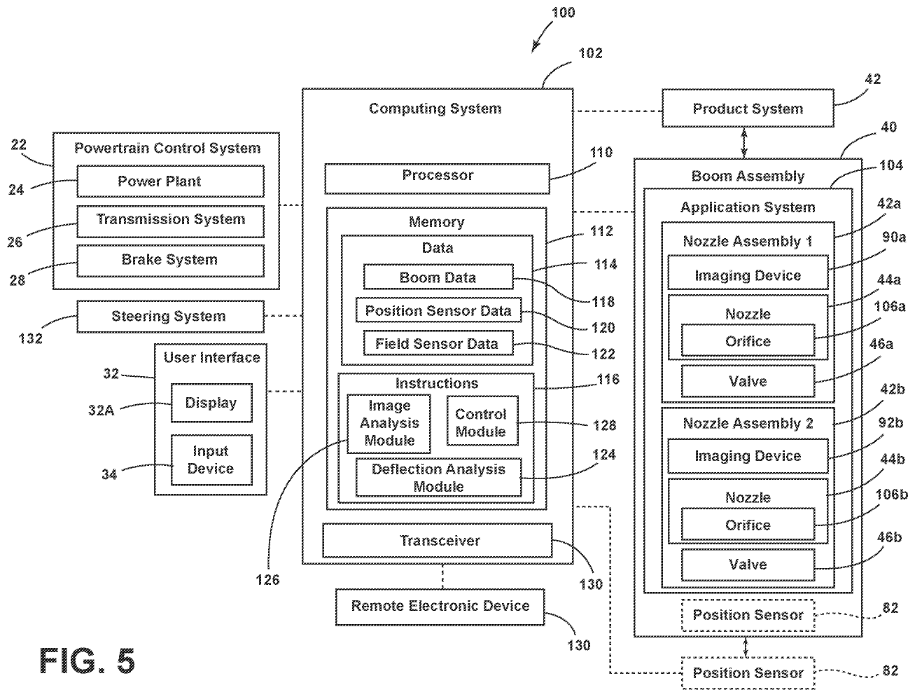

As shown, the boom assembly 40 may further include one or more field sensors 90 configured to capture data indicative of field conditions within the field 20. In several embodiments, each field sensor 90 may have a field of view or detection zone 92. In this regard, each field sensor 90 may be able to capture data indicative of objects and/or field conditions within its detection zone 92. For instance, in some embodiments, the field sensors 90 are object detecting/identifying imaging devices, where the data captured by the field sensors 90 may be indicative of the location and/or type of plants and/or other objects within the field 20. More particularly, in some embodiments, the data captured by the field sensors 90 may be used to allow various objects to be identified. For example, the data captured may allow a computing system 102 (FIG. 5) to distinguish weeds 96 from useful plants within the field 20 (e.g., crops 98). In such instances, the field sensor data may, for instance, be used within a spraying operation to selectively spray or treat a defined target 94, which may include the detected/identified weeds 96 (e.g., with a suitable herbicide) and/or the detected/identified crops 98 (e.g., with a nutrient).

It should be appreciated that the agricultural sprayer 10 may include any suitable number of field sensors 90 and should not be construed as being limited to the number of field sensors 90 shown in FIG. 4. Additionally, it should be appreciated that the field sensors 90 may generally correspond to any suitable sensing devices. For example, each field sensor 90 may correspond to any suitable cameras, such as single-spectrum camera or a multi-spectrum camera configured to capture images, for example, in the visible light range and/or infrared spectral range. Additionally, in various embodiments, the cameras may correspond to a single lens camera configured to capture two-dimensional images or a stereo cameras having two or more lenses with a separate image imaging device for each lens to allow the cameras to capture stereographic or three-dimensional images. Alternatively, the field sensors 90 may correspond to any other suitable image capture devices and/or other field sensors capable of capturing “images” or other image-like data of the field 20. For example, the field sensors 90 may correspond to or include radio detection and ranging (RADAR) sensors, light detection and ranging (LIDAR) sensors, and/or any other practicable device.

Referring now to FIG. 5, a schematic view of a system 100 for operating the sprayer 10 that is configured to apply agricultural product to defined targets 94 (FIG. 4) is illustrated in accordance with aspects of the present subject matter. In general, the system 100 will be described with reference to the sprayer 10 described above with reference to FIGS. 1-4. However, it should be appreciated by those of ordinary skill in the art that the disclosed system 100 may generally be utilized with agricultural machines having any other suitable machine configuration. Additionally, it should be appreciated that, for purposes of illustration, communicative links, or electrical couplings of the system 100 shown in FIG. 5 are indicated by dashed lines.

As shown in FIG. 5, the system 100 may include a computing system 102 operably coupled with an agricultural product application system 104 that may be configured to dispense an agricultural product from the product system 41 to the field 20 through one or more nozzle assemblies 42a, 42b that are positioned at least partially along the boom assembly 40. As illustrated in FIG. 5, in some instances, the application system 104 can include first and second nozzle assemblies 42a, 42b. However, it will be appreciated that the application system 104 can include any number of nozzle assemblies 42a, 42b without departing from the scope of the present disclosure.

In some embodiments, the first nozzle assembly 42a may be positioned along the boom assembly 40. The first nozzle assembly 42a can include a first valve 46a operably coupled with a first nozzle 44a and configured to control a flow of agricultural product through the first nozzle 44a. A second nozzle assembly 42b may be positioned along the boom assembly 40 on an opposing side of the first nozzle assembly 42a from a frame 48 (FIG. 1) of the boom assembly 40. The second nozzle assembly 42b can include a second valve 46b operably coupled with a second nozzle 44b and configured to control a flow of agricultural product through the second nozzle 44b.

The first and second nozzles 44a, 44b each define a respective orifice 106a, 106b that may dispense a fan 86 (FIG. 4) of the agricultural product. In some instances, the computing system 102 may be configured to distinguish various objects within the field 20 (e.g., e.g., weeds 96 (FIG. 4) versus crops 98 (FIG. 4)). In such instances, the application system 104 may perform a spraying operation to selectively spray or treat the defined target 94 from select nozzles 44a, 44b based on the target 94 being positioned within an application region 88 of the respective nozzle 44a, 44b.

In several embodiments, each nozzle 44a, 44b may include a respective valve 46a, 46b for activating the respective nozzle 44a, 44b when a target 94 is detected and determined to be present within an application region 88 of the nozzle 44a, 44b. The valves 46a, 46b can further include restrictive orifices, regulators, and/or the like to regulate the flow of agricultural product from the product tank 36 and/or the rinse tank 38 to each orifice 106a, 106b. In various embodiments, the valves 46a, 46b may be configured as electronically controlled valves that are controlled by a Pulse Width Modulation (PWM) signal for altering the application rate of the agricultural product.

In general, the computing system 102 may comprise any suitable processor-based device, such as a computing device or any suitable combination of computing devices. Thus, in several embodiments, the computing system 102 may include one or more processor 110 and associated memory 112 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 112 of the computing system 102 may generally comprise memory elements including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 112 may generally be configured to store information accessible to the processor 110, including data 114 that can be retrieved, manipulated, created, and/or stored by the processor 110 and instructions 116 that can be executed by the processor 110, when implemented by the processor 110, configure the computing system 102 to perform various computer-implemented functions, such as one or more aspects of the image processing algorithms and/or related methods described herein. In addition, the computing system 102 may also include various other suitable components, such as a communications circuit or module, one or more input/output channels, a data/control bus, and/or the like.

It will be appreciated that, in several embodiments, the computing system 102 may correspond to an existing controller of the agricultural machine 10, or the computing system 102 may correspond to a separate processing device. For instance, in some embodiments, the computing system 102 may form all or part of a separate plug-in module or computing device that is installed relative to the sprayer 10 or boom assembly 40 to allow for the disclosed system 100 and method to be implemented without requiring additional software to be uploaded onto existing control devices of the sprayer 10 or boom assembly 40.

In several embodiments, the data 114 may be information received and/or generated by the computing system 102 that is stored in one or more databases. For instance, as shown in FIG. 5, the memory 112 may include a boom database 118, which may be configured to store data and/or algorithms related to one or more boom assemblies that may be used by the system 100. For example, the boom database 118 may be configured to receive inputs related to and/or detect various boom characteristics, such as a length of the boom, a number of nozzles 44a, 44b along the boom, and/or any other data. In addition, the boom database 118 may include various algorithms, LUTs, etc. that are associated with each boom based on the boom characteristics.

In addition, the memory 112 may include a position sensor database 120 for storing position data received from the one or more position sensors 82. For example, the position sensors 82 may be configured to continuously or periodically capture data associated with a position of the boom assembly 40. In such embodiments, the data transmitted to the computing system 102 from the position sensors 82 may be stored within the position sensor database 120 for subsequent processing and/or analysis.

Further, as shown in FIG. 5, the memory 112 may include a field database 122 for storing vision-based data received from the field sensors 90a, 90b. For example, the field sensors 90a, 90b may be configured to continuously or periodically capture images of the field 20 or other image-like data associated with the field 20. In such embodiments, the data transmitted to the computing system 102 from the field sensors 90a, 90b may be stored within the field database 122 for subsequent processing and/or analysis. It should be appreciated that, as used herein, the terms vision-based data or image-like data may include any suitable type of data received from the field sensors 90a, 90b that allows for the objects and/or field conditions of a field 20 to be analyzed, including photographs or other images, RADAR data, LIDAR data, and/or other image-related data (e.g., scan data and/or the like).

In several embodiments, the instructions 116 stored within the memory 112 of the computing system 102 may be executed by the processor 110 to implement a deflection analysis module 124. In general, the deflection analysis module 124 may be configured to process/analyze the data received from the one or more position sensors 82 and the boom characteristics to estimate or determine a boom deflection model. Specifically, in several embodiments, the deflection analysis module 124 may be configured to execute one or more algorithms to determine a magnitude of deflection and/or a direction of movement to generate the boom deflection model.

Additionally or alternatively, the instructions 116 stored within the memory 112 of the computing system 102 may be executed by the processor 110 to implement an image analysis module 126. In general, the image analysis module 126 may be configured to process/analyze the images received from the field sensors 90a, 90b and/or the data deriving therefrom to identify one or more targets target 94 (FIG. 4) within the field 20 (FIG. 1). Specifically, in several embodiments, the image analysis module 126 may be configured to execute one or more image processing algorithms to determine a defined target 94 (FIG. 4) within the underlying field.

Referring still to FIG. 5, in some embodiments, the instructions 116 stored within the memory 112 of the computing system 102 may also be executed by the processor 110 to implement a control module 128. In general, the control module 128 may be configured to electronically control the operation of one or more components of the agricultural machine 10. For instance, in several embodiments, the control module 128 may be configured to control the operation of each nozzle assembly 42a, 42b based on the determined boom deflection model and a location of the target 94. For instance, based on the boom deflection model, the control module 128 may time an activation of a valve 46a, 46b to control the deposition of the agricultural product to selectively spray or treat the target 94 from a defined nozzle 44a, 44b. In addition, based on the position of the target 94 and the boom deflection model, the control module 128 may determine a predicted boundary of the application region 88 based on the movement of the nozzle assembly 42.

Further, as shown in FIG. 5, the computing system 102 may also include a transceiver 130 to allow for the computing system 102 to communicate with any of the various other system components described herein. For instance, one or more communicative links or interfaces (e.g., one or more data buses) may be provided between the transceiver 130 and the application system 104. In such instances, the images or other vision-based data captured by the field sensors 90a, 90b may be transmitted from the field sensors 90a, 90b to the computing system 102. Additionally or alternatively, the data provided by the one or more position sensors 82 may be transmitted from the one or more position sensors 82 to the computing system 102. In addition, the computing system 102 may provide instructions to activate/deactivate each valve 46a, 46b at various times to selectively spray or treat the target 94 based on the boom deflection model and the position of the identified target 94.

Similarly, one or more communicative links or interfaces may be provided between the transceiver 130 and the powertrain control system 22 that includes the power plant 24, the transmission system 26, and the brake system 28. Through the usage of any of these systems, the vehicle computing system 102 may collect data related to one or more vehicle conditions, such as speed variations that may cause the boom assembly 40 to move from its neutral position. In some instances, in addition to the computing system 102 determining a speed and direction of the boom arm deflection, the computing system 102 may also predict a future position of the boom based on the boom deflection model and the detected vehicle conditions. In turn, the computing system 102 may determine an upcoming activation time with the upcoming activation time defining a time in which a detected target 94 is to be positioned within an application region 88.

The power plant 24 is configured to vary the output of the engine to control the speed of the vehicle 10. For example, the power plant 24 may vary a throttle setting of the engine, a fuel/air mixture of the engine, a timing of the engine, and/or other suitable engine parameters to control engine output. In addition, the transmission system 26 may adjust gear selection within a transmission system 26 to control the speed of the vehicle 10. Furthermore, the brake system 28 may adjust braking force, thereby controlling the speed of the vehicle 10. While the illustrated powertrain control system 22 includes the power plant 24, the transmission system 26, and the brake system 28, it should be appreciated that alternative embodiments may include one or two of these systems, in any suitable combination. Further embodiments may include a powertrain control system 22 having other and/or additional systems to facilitate adjusting the speed of the vehicle 10.

Additionally or alternatively, one or more communicative links or interfaces (e.g., one or more data buses) may be provided between the transceiver 130 and a steering system 132 configured to control a direction of the vehicle 10 through manipulation of one or more wheels 14, 16 (FIG. 1) (or tracks). The steering system 132 may include a steering system sensor to provide data related to a steering direction of the vehicle 10 and/or a torque on the steering wheel indicating an operator's intention for manipulating the steering system 132. In some instances, in addition to the computing system 102 determining a speed and direction of the boom arm deflection, the computing system 102 may also predict a future position of the boom based on the steering conditions in addition to or in lieu of the vehicle conditions provided by the powertrain control system 22.

Further, one or more communicative links or interfaces may be provided between the transceiver 130 and a user interface, such as a user interface 32 housed within the cab 30 of the sprayer 10 or at any other suitable location. The user interface 32 may be configured to provide feedback to the operator of the agricultural machine 10. Thus, the user interface 32 may include one or more feedback devices, such as display screens 32A, speakers, warning lights, and/or the like, which are configured to communicate such feedback. In addition, some embodiments of the user interface 32 may include one or more input devices 34, such as touchscreens, keypads, touchpads, knobs, buttons, sliders, switches, mice, microphones, and/or the like, which are configured to receive user inputs from the operator.

Still further, one or more communicative links or interfaces may be provided between the transceiver 130 and a remote electronic device 134. The one or more communicative links or interfaces may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The electronic device 134 may also include a display for displaying information to a user. For instance, the electronic device 134 may display one or more user interfaces and may be capable of receiving remote user inputs. In addition, the electronic device 134 may provide feedback information, such as visual, audible, and tactile alerts and/or allow the operator to alter or adjust one or more components of the vehicle 10 or the boom assembly 40 through usage of the remote electronic device 134. It will be appreciated that the electronic device 134 may be any one of a variety of computing devices and may include a processor and memory. For example, the electronic device 134 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

In operation, the one or more field sensors 90a, 90b positioned along the boom assembly 40 may provide data related to one or more respective imaged portions of an agricultural field 20 (FIG. 1) to the computing system 102. As provided herein, the one or more field sensors 90a, 90b may provide vision-based data within various detection zone 92 that may be associated with each respective nozzle 44a, 44b along the boom assembly 40. Based on the data captured by the first field sensor 90a, the computing system 102 may be configured to identify a target 94 within the first imaged portion 140 of the agricultural field 20.

In addition, the one or position sensors 82 positioned along the boom assembly 40 may provide data related to a curvature of the boom assembly 40, which may then be used to define the boom deflection model. The boom deflection model may map a deflection of each nozzle assembly 42 from a default axis a_{d}, a nozzle speed or acceleration, and/or a direction of movement of each nozzle assembly 42 relative to the frame 48 (or other component of the sprayer 10). Thus, the boom deflection model may be used to determine an upcoming activation time for one or more nozzle assemblies 42 to exhaust the agricultural product on a defined target 94. Based on the position of the target 94 being determined to be within the application region 88, the system 100 may perform a spraying operation to selectively spray or treat the target 94. As such, a more accurate application of the agricultural product to the target 94 may be accomplished.

It will be appreciated that, although the various control functions and/or actions will generally be described herein as being executed by the computing system 102, one or more of such control functions/actions (or portions thereof) may be executed by a separate computing system 102 or may be distributed across two or more computing systems (including, for example, the computing system 102 and a separate computing system). For instance, in some embodiments, the computing system 102 may be configured to acquire data from the field sensors 90a, 90b for subsequent processing and/or analysis by a separate computing system (e.g., a computing system associated with a remote server). In other embodiments, the computing system 102 may be configured to execute the image analysis module 126 to determine and/or monitor one or more objects and/or field conditions within the field 20, while a separate computing system (e.g., a vehicle computing system associated with the agricultural machine 10) may be configured to execute the control module 128 to control the operation of the agricultural machine 10 based on data and/or instructions transmitted from the computing system 102 that are associated with the monitored objects and/or field conditions. Likewise, in some embodiments, the computing system 102 may be configured to acquire data from the one or more position sensors 82 for subsequent processing and/or analysis by a separate computing system (e.g., a computing system associated with a remote server). In other embodiments, the computing system 102 may be configured to execute the deflection analysis module 124 to determine a boom deflection model, while a separate computing system (e.g., a vehicle computing system associated with the agricultural machine 10) may be configured to execute the control module 128 to control the operation of the agricultural machine 10 based on data and/or instructions transmitted from the computing system 102 that are associated with the boom deflection model.

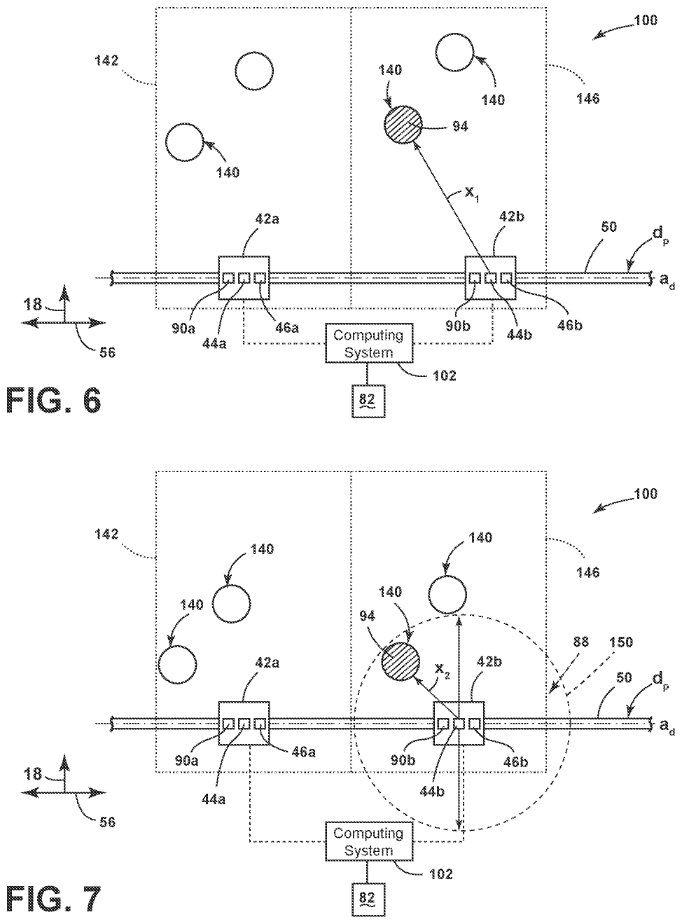

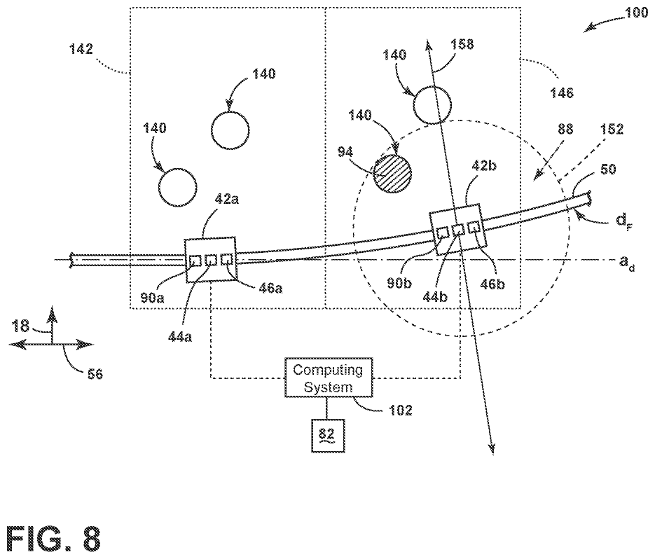

Referring now to FIGS. 6-8, schematic views of a first nozzle assembly 42a and a second nozzle assembly 42b positioned along a boom arm 50 are illustrated in accordance with various aspects of the present disclosure. Specifically, FIGS. 6 and 7 illustrate the system 100 with the first boom arm 50 generally extending along in a default position dₚ. FIG. 8 illustrates the system 100 with the first boom arm 50 generally extending in a fore direction d_{f}.

With reference to FIGS. 6-8, the system 100 may include a first nozzle assembly 42a that includes a first field sensor 90a, a first nozzle 44a, and a first valve 46a. The system 100 may also include a second nozzle assembly 42b that includes a second field sensor 90b, a second nozzle 44b, and a second valve 46b. Each of the first and second field sensors 90a, 90b may be able to capture data indicative of one or more objects within its detection zone 92. For instance, in some embodiments, the data captured by the field sensors 90a, 90b is indicative of the location and/or type of plants within the field 20. In response to receiving the data captured by the field sensors 90a, 90b, the computing system 102 may identify targets 94 to be distinguished within the field 20 (e.g., weeds 96 (FIG. 4) versus crops 98 (FIG. 4)).

In addition, the position sensors 82 may be configured to capture data indicative of a curvature of the boom assembly 40. Based on the curvature of the boom assembly 40, the computing system 102 may calculate a deflection magnitude and/or a deflection direction of the boom assembly 40 to define a boom deflection model that may map a deflection of each nozzle assembly 42 from a default axis a_{d}, a nozzle speed or acceleration, and/or a direction of movement of each nozzle assembly 42 relative to the frame 48 (or other component of the sprayer 10).

In various embodiments, based on the determination that a target 94 is present within the field 20 and a determined boom deflection model, the system 100 may perform a spraying operation to selectively spray or treat the target 94 while the target 94 is within a defined application region 88 of a nozzle 44a, 44b.

With further reference to FIGS. 6 and 7, in several embodiments, the first field sensor 90a may provide the computing system 102 with data indicative of a first imaged portion 142 (FIG. 6) of the field 20 and a second imaged portion 144 (FIG. 7) of the field 20. Likewise, the second field sensor 90b may provide the computing system 102 with data indicative of a third imaged portion 146 (FIG. 6) of the field 20 and a fourth imaged portion 148 (FIG. 7) of the field 20.

As illustrated in FIG. 6, a plurality of objects may be present within the imaged portions of the field. In addition, a target 94 may be identified as a location that is to have an agricultural product applied thereto by the second nozzle 44b. However, the target 94 is positioned an initial distance X₁ that is external of the application region 88. As such, the computing system 102 may monitor successive imaged portions of the field 20 and the boom deflection model to determine when the target 94 is positioned within the application region 88.

As illustrated in FIG. 7, as the sprayer 10 (FIG. 1) travels along the direction of forward travel 18, the position sensor 82 may provide data to the computing system indicative of a curvature of the boom assembly 40. Based on the data provided from the position sensor 82, the computing system 102 may utilize geometric equations, LUTs, and/or any other method to determine a time in which the target 94 is a distance X₂ from the second nozzle 44b that is within the application region 88 of the second nozzle 44b. In such instances, the computing system 102 may activate the second valve 46b of the second nozzle assembly 42b to apply the agricultural product to the target 94.

Referring now to FIG. 8, in some instances, the boom arm 50 may be deflected from the default axis a_{d}, which is generally illustrated in FIGS. 6 and 7. In such instances, the timing of the activation of the first nozzle assembly 42a and/or the second nozzle assembly 42b may be varied based on the speed of the first nozzle assembly 42a, the direction of movement of the first nozzle assembly 42a, the speed of the second nozzle assembly 42b, the direction of movement of the second nozzle assembly 42b, and/or differences between the speed and/or direction of the first nozzle assembly 42a compared to the second nozzle assembly 42b, which may all be identified within the boom deflection model.

In addition, when the boom assembly 40 is deflected from the default axis a_{d}, the geometric shape of the application region 88 may be altered and/or rotated relative to the default axis a_{d}. For instance, as illustrated in FIG. 7, a boundary 150 of the application region 88 can define a first geometric shape having a first area at a defined distance from the nozzle 44 when the nozzle 44 is traveling at a first speed. Conversely, as illustrated in FIG. 8, a boundary 152 of the application region 88 can define a second geometric shape having a second area at the defined distance from the nozzle 44 when the nozzle 44 is traveling at a second speed. In various embodiments, the first area can be different than the second area and the first speed can be different from the second speed.

In the embodiments illustrated in FIGS. 7 and 8, when the boom assembly 40 is positioned in the default position, the application region 88 may be generally symmetrical to the default axis a_{d} and/or a longitudinal axis 156 of the application region 88 may be perpendicular to the default axis a_{d}. However, when the boom assembly 40 is deflected, the application region 88 may be asymmetrical to the default axis a_{d} and/or a longitudinal axis 158 of the application region 88 may be non-perpendicular to the default axis a_{d}. Accordingly, in addition to the boom deflection model determining that the target 94 may be approaching a defined nozzle assembly 42 prior to (and/or after) the default axis a_{d}, the boom deflection model may also determine a boundary of the application region 88 as the target 94 approaches the boom assembly 40 such that the computing system 102 can more accurately activate the second nozzle 44b when the target 94 is within the application region 88 with the boom deflected.

Additionally or alternatively, the computing system 102 may activate the second valve 46b when the target 94 is projected to pass through the application region 88 a second time due to oscillation of the boom assembly 40 based on the boom deflection model. In such instances, multiple applications of the agricultural product may be applied to a common target 94, and/or multiple attempts may be performed on a single target 94 to further ensure that the target 94 was contacted by the agricultural product.

While the example provided in FIGS. 6-8 illustrates a target 94 within an application region 88 of the second nozzle assembly 42b, it will be appreciated that the target 94 may be associated with any nozzle assembly 42 of the sprayer 10 without departing from the teachings of the present disclosure.

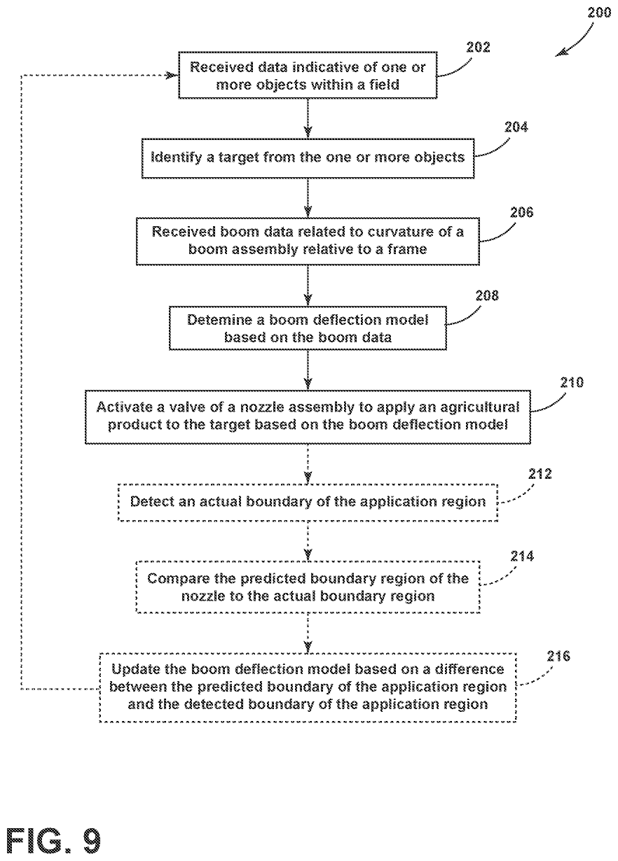

Referring now to FIG. 9, a flow diagram of some embodiments of a method 200 for selectively applying an agricultural product is illustrated in accordance with aspects of the present subject matter. In general, the method 200 will be described herein with reference to the sprayer 10 and the system 100 described above with reference to FIGS. 1-8. However, it will be appreciated by those of ordinary skill in the art that the disclosed method 200 may generally be utilized with any suitable agricultural sprayer 10 and/or may be utilized in connection with a system having any other suitable system configuration. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 9, at (202), the method 200 can include receiving data indicative of one or more objects within a field. As provided herein, the data indicative of one or more objects within the field may include receiving image data from a field sensor. Further, the field sensor may have a detection zone that at least partially overlaps with an actual application region of the nozzle as determined by the boom deflection model.

At (204), the method 200 can include identifying a target from the one or more objects, which may include the detected/identified weeds (e.g., with a suitable herbicide) and/or the detected/identified crops (e.g., with a nutrient).

At (206), the method 200 can include receive boom data related to curvature of a boom assembly relative to a frame. As provided herein, the boom data may be generated by a position sensor.

At (208), the method 200 can include determine a boom deflection model based on the boom data. In various embodiments, the boom deflection model may map a nozzle speed or acceleration and a direction of movement of each nozzle assembly relative to the frame (or other component of the sprayer). Additionally or alternatively, the boom deflection model may define a predicted boundary of an application region of the nozzle assembly based on the nozzle speed or acceleration and the direction of movement of each nozzle assembly relative to the default axis.

At (210), the method 200 can include activating a valve of a nozzle assembly to apply an agricultural product to the target based on the boom deflection model. As provided herein, with the valve of the nozzle assembly activated, the nozzle assembly may dispense or otherwise spray a fan of the agricultural product onto the target when the target is in an application region that corresponds to an area for which the agricultural product exhausted from the nozzle may contact. In various instances, the application region may be varied based on a variety of factors, which can include, but are not limited to, sprayer conditions (e.g., speed of the sprayer, direction of travel of the sprayer, acceleration of the sprayer, etc.), boom conditions (e.g., speed of the nozzle assembly, deflection magnitude of the assembly from a default position, acceleration of the nozzle assembly, direction of movement of the nozzle assembly relative to the frame 48 and/or the underlying field, etc.), environmental conditions (e.g., wind speed, wind direction, percent humidity, ambient temperature, etc.), and/or any other factors.

At (212), the method 200 can include detecting an actual boundary of the application region. In various embodiments, the actual boundary of the application region may be detected by the field sensors.

At (214), the method 200 can include comparing the predicted boundary of the nozzle to the actual boundary. At (216), the method 200 can include updating the boom deflection model based on a difference between the predicted boundary of the application region and the detected boundary of the application region. The updating of the boom deflection model may include updating any of the various factors that may affect the application region of the nozzle assembly.

In various examples, the method may implement machine learning methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for an agricultural vehicle, the system comprising:
a boom assembly;
a nozzle assembly positioned along the boom assembly;
a position sensor associated with the boom assembly;
a field sensor associated with the nozzle assembly; and
a computing system operably coupled with the nozzle assembly, the position sensor, and the field sensor, the computing system configured to:
detect a target within a field based on data from the field sensor;
determine a boom deflection model based on data from the position sensor; and
activate the nozzle assembly to apply an agricultural product to the target based on the boom deflection model.

2. The system of claim 1, wherein the boom deflection model predicts a boom curvature and a speed of movement of the nozzle assembly relative to a chassis of the vehicle.

3. The system of claim 1, wherein the position sensor comprises at least one of an accelerometer, a pressure sensor, a LIDAR sensor, a RADAR sensor, or an ultrasonic sensor.

4. The system of claim 1, wherein the position sensor is configured as a pressure sensor integrated into at least one actuator of the boom assembly.

5. The system of claim 1, wherein the nozzle assembly includes a valve operably coupled with a nozzle and configured to control a flow of agricultural product through the nozzle.

6. The system of claim 2, wherein the agricultural product is exhausted from the nozzle towards the target that is a first distance from a default axis when the boom assembly is generally aligned with the default axis, and wherein the agricultural product is exhausted from the nozzle towards the target that is a second distance from the default axis when the boom assembly is deflected.

7. The system of claim 5, wherein the computing system is further configured to:
activate the valve when the target is projected to pass through an application region a second time due to oscillation of the boom assembly based on the boom deflection model.

8. The system of claim 1, wherein an application region defines an area of an underlying field from that is contacted by agricultural product when the nozzle is actuated from an off position to a spray position.

9. The system of claim 1, wherein the boom deflection model is configured to determine a geometric boundary of an application region of the nozzle assembly, and the nozzle assembly is activated when the target is within the application region of the nozzle assembly based on the boom deflection model.

10. A method for selectively applying an agricultural product, the method comprising:
receiving, with a computing system, data indicative of one or more objects within a field;
identifying, with the computing system, a target from the one or more objects;
receiving, with the computing system, boom data related to curvature of a boom assembly relative to a frame; and
determining, with the computing system, a boom deflection model based on the boom data.

11. The method of claim 10, further comprising:
activating, with the computing system, a valve of a nozzle assembly to apply an agricultural product to the target based on the boom deflection model.

12. The method of claim 11, wherein receiving data indicative of one or more objects within a field further comprises receiving image data from a field sensor.

13. The method of claim 12, wherein the field sensor has a detection zone that at least partially overlaps with an actual application region of the nozzle as determined by the boom deflection model.

14. The method of claim 11, wherein the boom deflection model defines a predicted boundary of an application region of the nozzle.

15. The method of claim 14, further comprising:
detecting, through a field sensor, an actual boundary of the application region;
comparing, through the computing system, the predicted boundary of the nozzle to the actual boundary; and
updating, through the computing system, the boom deflection model based on a difference between the predicted boundary of the application region and the detected boundary of the application region.

16. A system for an agricultural vehicle, the system comprising:
a boom assembly;
a nozzle assembly positioned along the boom assembly;
a position sensor associated with the boom assembly; and
a computing system operably coupled with the nozzle assembly and the position sensor, the computing system configured to:
receive data from the position sensor;
determine a boom deflection model based on the data from the position sensor; and
determine a boundary of an application region based on the boom deflection model.

17. The system of claim 16, further comprising:
a field sensor associated with the nozzle assembly, wherein the computing system is further operably coupled with the field sensor, and wherein the computing system is further configured to:
detect a target within a field based on data from the field sensor; and
activate the nozzle assembly to apply an agricultural product to the target based on the boom deflection model.

18. The system of claim 17, wherein the boom deflection model determines a magnitude of fore-aft deflection of the boom assembly and a speed of movement of the nozzle assembly relative to an underlying field and/or relative to the vehicle.

19. The system of claim 17, wherein the boundary of the application region defines a first geometric shape having a first area at a defined distance from the nozzle when the nozzle is traveling at a first speed and a second geometric shape having a second area at the defined distance from the nozzle when the nozzle is traveling at a second speed, and wherein the first area is different than the second area.

20. The system of claim 17, wherein the boundary of the application region defines a longitudinal axis, and wherein the boom deflection model determines an offset of the longitudinal axis relative to a default axis.
